(19) United States
(12) Patent Application Publication
(10) Pub. No.: US 2005/0177653 A1
(43) Pub. Date: Aug. 11, 2005

(54) Apparatus and method for installing a AV system easily and flexibly

(75) Inventor: Andy Chiu, Taipei (TW)

Correspondence Address: BIRCH STEWART KOLASCH & BIRCH, PO BOX 747, FALLS CHURCH, VA, 22040-0747, US

(73) Assignee: VIA TECHNOLOGIES, INC., Taipei (TW)

(21) Appl. No.: 11/047,853

(22) Filed: Feb. 2, 2005

Related U.S. Application Data
(60) Provisional application No. 60/541,919, filed on Feb. 6, 2004.

(51) Int. Cl. H04N 9/74

(52) U.S. Cl. 710/15; 710/8

(57) ABSTRACT

The present invention discloses a method and an apparatus for adjusting an input and output of an audio/video system, and the method detects the number of connected terminals and the switcher output signal at a connected terminal to determine the correct configuration of signal used for the connected terminal, and the apparatus for adjusting an input and output of an audio/video system comprises a switcher, a digital-to-analog converter and a control unit, wherein the switcher is used to receive a plurality of audio/video signal to switcher and output a plurality of output signals to a plurality of terminals of the control unit, and receive a data stream to produce the corresponding analog audio/video signal; the control unit is used to control the switcher and output of the switcher according to the connect signal as to provide the flexibility of connecting the audio/video equipments and save the system cost.

### 1. FIELD OF THE INVENTION

The present invention relates to a method for connecting audio/video system, and more particularly, to an I/O apparatus and method of an audio/video system capable of configuration detection and output switching.

### 2. BACKGROUND OF THE INVENTION

At present, the external interface of an audio/video equipment usually comprises a plurality of terminals for connecting with other A/V devices, such as composite video input (CVBS), S-Video (Y/C) output, and chroma signal (component, Y, P_{b}, Pᵣ) output, etc. Since there are various different kinds of terminals on the audio/video equipment, it is quite common for a user to mix up with the terminals and install the connectors to the wrong terminals while the user wants to install an external device to the A/V system despite that the shape of these terminals are not identical.

Please refer to FIG. 1, which is an illustration showing an input/output rear panel of a conventional DVD player. The input/output rear panel 100 comprises a power terminal 110, a display device adjusting terminal 111, a video signal input terminal 113, a S-video signal input terminal 114, an audio signal input terminal 115, a 5.1-channel audio signal output terminal 120, a video signal output terminal 130, a S-video signal output terminal 140, a chroma video signal output terminal 150, an optical fiber output terminal (audio) 160, and a coaxial cable output terminal (video) 170.

Since the shapes of the video signal input terminal 113, audio signal input terminal 115, 5.1 channel audio signal output terminal 120, video signal output terminal 130, and chroma video signal output terminal 150 are identical or alike, it is quite easy for an user to install the connectors to the wrong terminals while the user wants to install an external device (not shown in the figure) to the A/V system.

### SUMMARY OF THE INVENTION

The invention provides an apparatus for adjusting the input and output of an audio/video system including a switcher, a plurality of digital-to-analog converters and a control unit; wherein each digital-to-analog converter is used for converting a digital signal into an analog signal and detecting the connection status corresponding to a load thereof for generating a connect signal; the switcher is adapted for outputting the digital signal to a corresponding digital-to-analog converter; and the control unit controls the output of the switcher according to the connect signal.

The invention further provides a method for adjusting the input and output of an audio/video system including the steps of: detecting the number of connected input and output terminals to produce a connect signal; comparing the connect signal with a configuration table including all possible configurations corresponding to the number of connected input and output terminals; and automatically scanning all possible configurations in sequence and then saving a correct configuration while the terminal is connected correctly.

Moreover, the invention provides a digital media player including a control chip detecting the connection status of terminals arranged on an input/output rear panel of the digital media player to adjust the signal output path and output signals to the corresponding terminals on the input/output rear panel; a man-machine interface enabling users to manually set a correct configuration and send an interrupt signal to the control unit; and the input/output rear panel, having a plurality of terminals arranged thereon, connecting with display devices and input devices, and capable of receiving an output signal of the control chip.

The method and apparatus of adjusting the input and output of an audio/video system according to the present invention allows users to connect an audio/video equipment without being troubled by the connection of the inputs to the corresponding output terminals, and also simplifies the connection between cables and the corresponding terminals while connecting an audio/video device to another audio/video device as to provide better flexibility and save system costs.

### BRIEF DESCRIPTION OF THE DRAWINGS

FIG. 1 is an illustration showing an input/output rear panel of a conventional DVD player.

FIG. 2 is a circuitry of the apparatus for adjusting an input and output of an audio/video system according to a preferred embodiment of the present invention.

FIGS. 3A, 3B, 3C and 3D are schematic illustrations showing the apparatus for adjusting an input and output of an audio/video system according to different embodiments of the present invention.

FIG. 4 is a schematic illustration showing the apparatus for adjusting an input and output of an audio/video system according to another preferred embodiment of the present invention.

FIG. 5 is a flow chart of the method for adjusting an input and output of an audio/video system according to a preferred embodiment of the present invention.

FIG. 6 is a schematic illustration showing a digital multimedia player according to a preferred embodiment of the present invention.

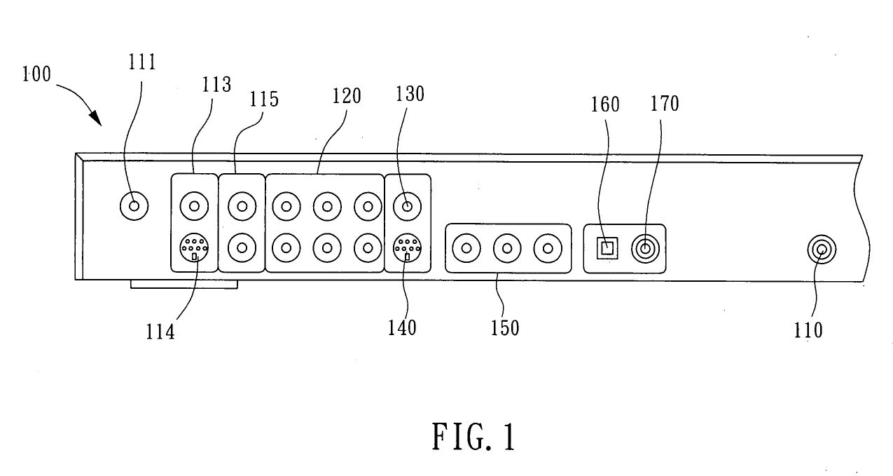

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

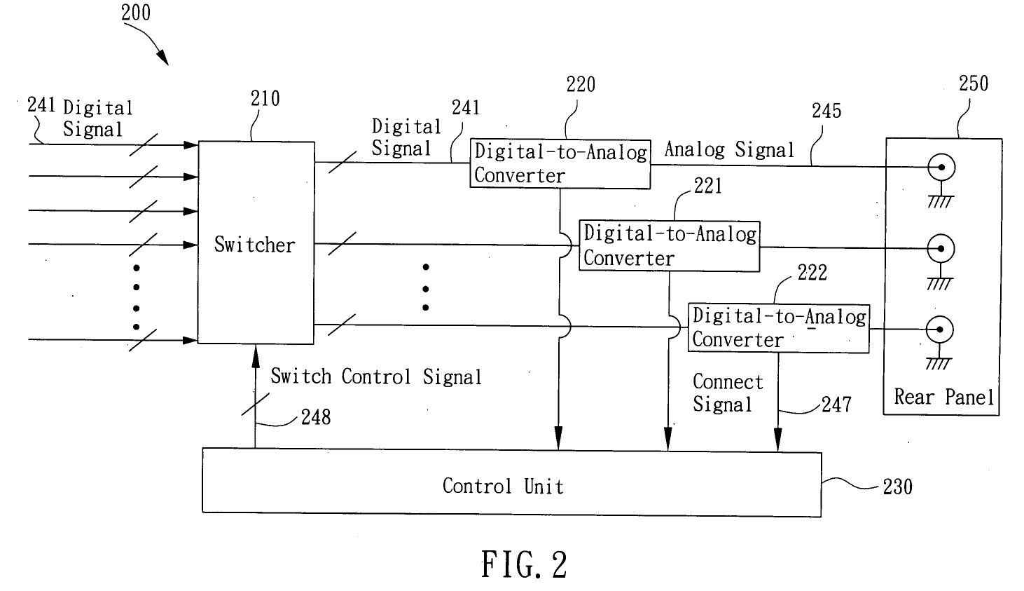

FIG. 2 shows a circuitry of the apparatus for adjusting an input and output of an audio/video system according to a preferred embodiment of the present invention, where the audio/video system according to this embodiment is a DVD player. In FIG. 2, the apparatus 200 for adjusting the input and output of an audio/video system comprises a switcher 210, a digital-to-analog converter 220 and a control unit 230; wherein the digital-to-analog converter 220 is capable of receiving a signal, such as a n-bit digital signal 241 outputted from a DVD player while playing an optical disk, and converting the n-bit digital signal into an analog signal 245; and the digital-to-analog converter 220 is capable of issuing a connect signal 247 to the control unit 230 for informing the control unit 230 about which terminal on the apparatus 220 is connected to a cable while the terminals of an input/output rear panel 250 of the audio/video system is connected to a load; and the control unit 230 is adapted for issuing a switch control signal 248 to the switcher 210; and the switcher 210 selects an appropriate signal and an appropriate output path from the n digital signals 241. For example, if the number of connected terminals is 1, then such terminal is outputting a CVBS signal; if the number of connected terminals is 2, then such terminal is outputting a S-Video signal; if the number of connected terminals is 3, then such terminal may output R, G, and B signals or Y, C_{b} and Cᵣ signals or Y, P_{b} and Pᵣ signals, etc.

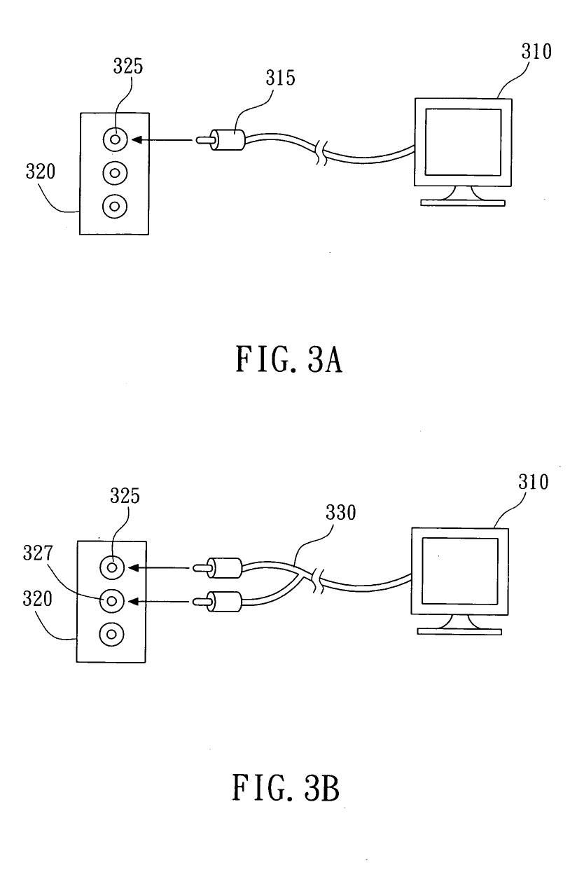

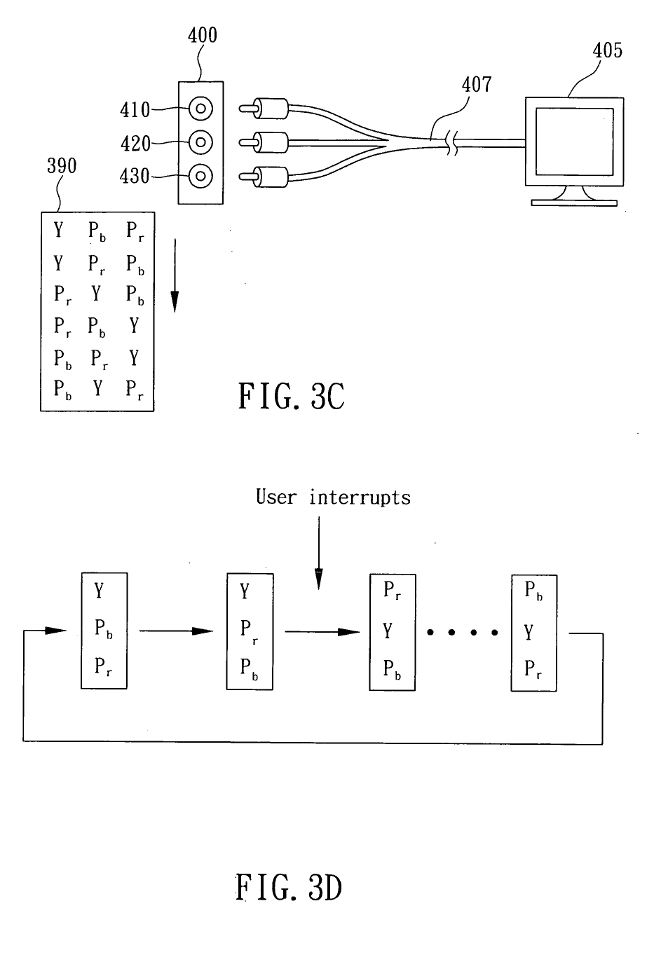

Please refer to FIGS. 3A, 3B, and 3C, which are schematic illustrations showing the apparatus for adjusting an input and output of an audio/video system according to different embodiments of the present invention. In FIG. 3A, if a display device 310 uses a cable 315 of one connector to connect an apparatus 320 for adjusting the input and output of the audio/video system, the I/O apparatus 320 will detect only one terminal 325 being connected to the cable 315 and determine that the signal corresponding to the terminal 325 is a CVBS signal. Therefore, the apparatus 320 for adjusting the input and output of the audio/video system requires only one scan process to find out the signal corresponding to the condition that only the terminal 325 and the cable 315 are connected.

In FIG. 3B, if the display device 310 uses a cable 330 of two connectors to connect the apparatus 320 for adjusting the input and output of the audio/video system, the I/O apparatus 320 will detect that there are two terminals 325 and 327 being connected to the cable 330 of two connectors, and determine that the corresponding signals received by the two terminals 325, 327 are S-Video signals (Y and C). However, the I/O apparatus 320 cannot determine whether or not the output signals of the terminals 325 and 327 correspond to the two connectors of the cables 330. Therefore, all possible configurations of the terminals 325 and 327 corresponding to the S-video signal are scanned. That is, since the Y signal may correspond to the terminal 325 and C signal may correspond to the terminal 327, or C signal may correspond to the terminal 325 and Y signal may correspond to the terminal 327, after the I/O apparatus 320 had perform two scan processes for enabling the output of the Y signal and C signal to switch between the terminals 325 and 327 such that the correct setting of the terminals 325 and 327 can be determined while the display screen of the display device 310 is normal. For instance, it can be determined that the terminal is correctly connected while the color bar of the display device 310 is displayed normally.

In FIG. 3C, if the display device 310 uses a cable 350 of three connectors to connect the terminals 360, 370 and 380 of the apparatus 320 for adjusting the input and output of the audio/video system and the I/O apparatus 320 only provides a chroma signal (Y, P_{b} and Pᵣ) output, the signal used for the output of the connectors of the cable 350 corresponding to the terminals 360, 370, 380 could be any permutation of the signal Y, signal P_{b} and signal Pᵣ as shown in the configuration table 390. The I/O apparatus 320 switches the output signals of the terminals 360, 370 and 380 in sequence according to such permutation and determines the signal correctly used for the cable 350 corresponding to the terminals 360, 370 and 380 by the situation whether or not the output signals of the terminal 360, 370 and 380 are displayed normally on the screen of the display device 310 in order to establish a correct connection between the I/O apparatus 320 and the display device 310.

Please also refer to FIG. 3D, which is a schematic representation depicting a scanning sequence of the apparatus for adjusting the input and output of the audio/video system according to a preferred embodiment of the present invention. As seen in FIG. 3C, the configuration table 390 has six permutations and thus the control unit is set to follow a predetermined sequence to automatically scan through all possible configurations by a predetermined time interval t for switching the audio and video signal output. In addition, the scanning can be interrupted for saving a correct configuration while a user uses a man-machine interface (such as a remote controller or a press button on a panel, etc) to stop the scan.

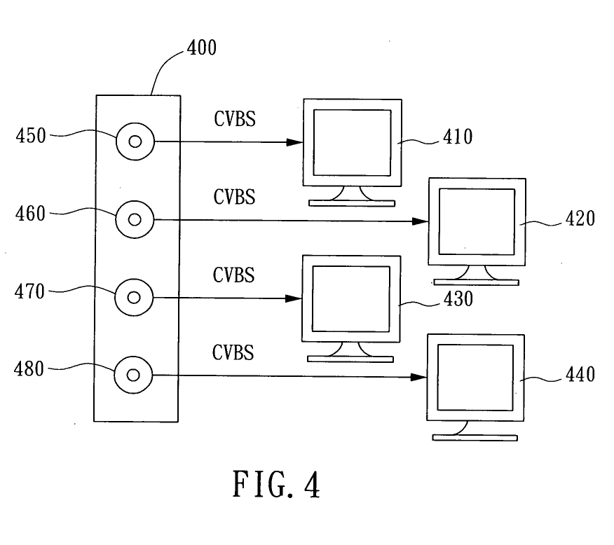

The I/O apparatus of the present invention not only can automatically switch the outputs of the terminals thereof for enabling the A/V system using the I/O apparatus of the invention to correctly connect with other A/V system, but also the I/O apparatus of the invention is capable of enabling users to set the output signals of the I/O apparatus. Please refer to FIG. 4 for the apparatus for adjusting the input and output of the audio/video system according to another preferred embodiment of the present invention. If the apparatus 400 for adjusting the input and output of the audio/video system is connected to four display devices 410, 420, 430 and 440, the outputs of the four terminals 450, 460, 470 and 480 of the I/O apparatus 400 can be set as CVBS signal outputs.

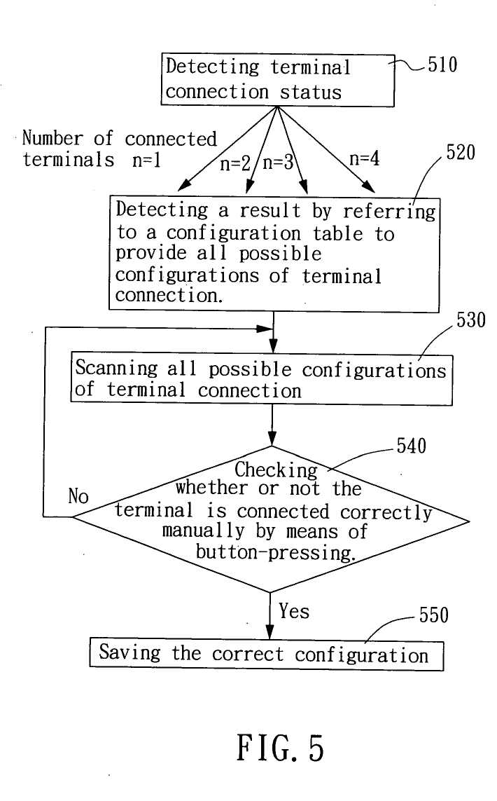

Please refer to FIG. 5, which is a flow chart of the method for adjusting an input and output of an audio/video system according to a preferred embodiment of the present invention. In step 510, the apparatus for adjusting the input and output of the audio/video system detects the number of connected terminals to obtain a detection result, wherein the number of connected terminals is at least one. In step 520, the detection result is compared with a configuration table to provide all possible configurations of terminal connection of the detection result. In step 530, all these possible configurations are scanned automatically in sequence and while each configuration is scanned. In step 540, if the terminal is connected correctly, a man-machine interface is used to stop the scanning of configurations manually, and then the flow goes to step 550; otherwise, the flow resume the scanning of the next configuration. In step 550, a correct configuration is saved. Users can use a built-in color bar of the display device to check whether or not the output signal of the connected terminal can enable the display device to display a screen normally; if so, users can manually press a button provided by a selection menu shown on the display device to confirm that the display is normal, and save the configuration (e.g. the configuration can be saved in an electronic form into an EEPROM), so that the connected terminal can use the signals with the correct configuration. In other words, the method and apparatus for adjusting the input and output of the audio/video system according to the present invention is divided into manual mode and automatic mode; wherein the manual mode provides users a way to perform the setup to each terminal individually while the automatic mode cannot satisfy the setup for a user's special configuration (as shown in this embodiment). Therefore, in the flow chart as shown in FIG. 5, if the manual mode is adopted, then Step 540 will be included.

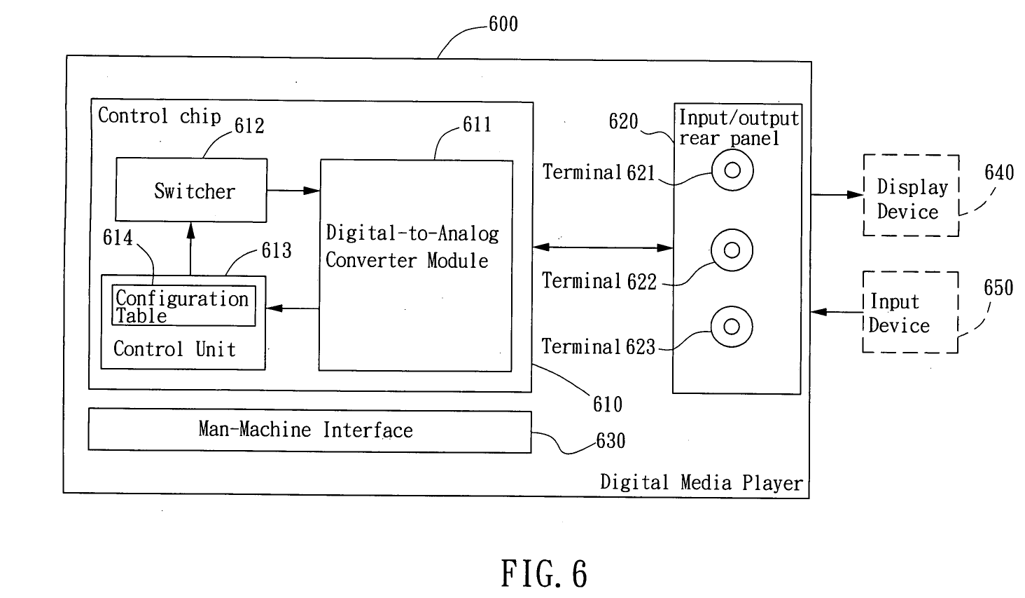

Please refer to FIG. 6, which is a schematic illustration showing a digital multimedia player according to a preferred embodiment of the present invention. The digital media player 600 includes a control chip 610 detecting the connection status of a terminal (terminal 621, 622 and 623 as adopted in this embodiment) on the input/output rear panel 620 to adjust the signal output path and output the output signal to the corresponding output terminal (such as terminal 621); a man-machine interface 630 providing users a manual mode to set up a correct configuration and transmit an interrupt signal to the control chip 610; and an input/output rear panel providing the terminal to connect a display device 640 and an input device 650, and receiving an output signal of the control chip 610.

The control chip 610 further includes a digital-to-analog converter module 611, each digital-to-analog converter detecting a connection status of a corresponding load and converting a digital signal into an analog signal and outputting the analog signal to a terminal of the input/output rear panel 620; a switcher 612 outputting the digital signal to one of the corresponding digital-to-analog converters; and a control unit 613 controlling an output path of the switcher 612 according to the connect signal. The control unit 613 further comprises a configuration table 614 including all configurations of the connect signal. For example, when there are three terminals are connected which represents there are six possible configurations, the control unit 613 then will scan each configuration within a predetermined time interval automatically to control the switcher 612 for switching the audio/video signal output.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. An apparatus for adjusting input and output of an audio/video system, comprising:
a plurality of digital-to-analog converters, each digital-to-analog converter being used to convert a digital signal into an analog signal and detect a connection status of a corresponding load to produce a connect signal;
a switcher, for outputting said digital signal to the corresponding one of said plural digital-to-analog converters; and
a control unit, for controlling the output of said switcher according to said connection status.

2. The apparatus of claim 1, wherein said control unit comprises:
a configuration table, including every configuration of said connect signal, for enabling said control unit to scan each configuration within a predetermined time interval automatically and control the output of the switcher.

3. The apparatus of claim 2, wherein said control unit is an electronic erasable programmable read only memory (EEPROM).

4. The apparatus of claim 1, wherein the apparatus is integrated in a control chip.

5. The apparatus of claim 1, wherein the apparatus further comprises a man-machine interface for providing users to set up a configuration.

6. The apparatus of claim 1, wherein the apparatus further comprises an input/output rear panel for arranging a plurality of I/O terminals thereon.

7. A method for adjusting input and output of audio/video system, comprising:
detecting a connection number of a plurality of input/output terminal to produce a connect signal;
referring to a configuration table according to said connect signal; wherein said configuration table includes all possible configurations corresponding to said connection number; and
automatically scanning all possible configurations in order; and saving a correct configuration while said plural terminals are connected correctly.

8. The method of claim 7 further comprising:
using a man-machine interface to interrupt the scanning while saving a present configuration.

9. The method of claim 8, further comprising:
providing a menu for user to select an option in said menu for interrupting said scanning.

10. The method of claim 8, further comprising:
using an input device to interrupt said scanning for setting and saving said present configuration.

11. The method of claim 9, further comprising:
connecting a plurality of display devices to a plurality of output terminals.

12. The method of claim 11, further comprising:
respectively setting up a signal used for a corresponding output terminal while at least four display devices are connected.

13. The method of claim 7, further comprising:
using a color bar displayed in a display device to determine whether the plural terminals are correctly connected.

14. A digital media player, comprising:
a control chip, for detecting the connection status of a plurality of terminals arranged on an input/output rear panel of said digital media player to adjust the signal output path and output signals to the corresponding terminals on said input/output rear panel;
a man-machine interface, for enabling users to manually set a correct configuration and send an interrupt signal to said control unit; and
said input/output rear panel, having the plural terminals arranged thereon for connecting with display devices and input devices, and capable of receiving output signals of said control chip.

15. The digital media player of claim 14, wherein said control chip further comprises:
a digital-to-analog converter module, having a plurality of digital-to-analog converters arranged therein, each digital-to-analog converter being capable of detecting the load connection status of the corresponding terminal to produce a connect signal and converting a digital signal into an analog signal and outputting the analog signal to the input/output rear panel;
a switcher, for outputting said digital signal to a corresponding one of said plural g digital-to-analog converters; and
a control unit, for controlling an output path of said switcher according to said connect signal.

16. The digital media player of claim 15, wherein said control unit further comprises:
a configuration table, including every configuration of said connect signal, for enabling said control unit to scan each configuration within a predetermined time interval automatically and control the output of the switcher.
